(19) United States
(12) Patent Application Publication
(10) Pub. No.: US 2013/0125646 A1
(43) Pub. Date: May 23, 2013

(54) SYSTEMS AND METHODS FOR MONITORING AND TRACKING HEALTH RELATED ACTIVITIES

(71) Applicants: Joel H. Dunlap, JR., Fox, AR (US); Brock U. Dunlap, Shirley, AR (US); Wade W. Dunlap, AFton, WY (US); Jesse Green, Conway, AR (US); Kevin Tierney, Conway, AR (US)

(72) Inventors: Joel H. Dunlap, JR., Fox, AR (US); Brock U. Dunlap, Shirley, AR (US); Wade W. Dunlap, AFton, WY (US); Jesse Green, Conway, AR (US); Kevin Tierney, Conway, AR (US)

(21) Appl. No.: 13/302,118

(22) Filed: Nov. 22, 2011

(51) Int. Cl. G01F 23/30; G01F 23/00

(52) U.S. Cl. 73/305; 73/290 R

(57) ABSTRACT

Monitoring and/or tracking systems and devices and methods for making and using the same are described. In some configurations, a system includes the following components: a stationary mounting surface defining an environment; a transmitter coupled to the stationary mounting surface; and a switch having a closed state and an open state. In various configurations, the switch is coupled to the stationary mounting surface and is in electrical communication with the transmitter. In various configurations, the switch occupies the closed state when the environment is in a first condition, the switch is toggled to the open state when the environment is in a second condition and the switch returns to the closed state when the environment returns to the first condition. In some configurations, the transmitter transmits discrete electrical signals corresponding with the closed state and the open state of the switch, respectively. Other embodiments are described.

### FIELD

This application relates generally to systems, devices and methods for monitoring and/or tracking health related activities. More specifically, this application describes systems and devices for monitoring and/or tracking certain activities of an infirm individual, including the use of restroom facilities and/or medication dispensers, and methods for making and using such systems and devices.

### BACKGROUND

Persons who are infirm, sick, wounded or otherwise in poor or ailing health often require medical attention from a healthcare professional, such as a nurse or a doctor. In some instances, certain individuals, such as the elderly or other persons who are chronically ill, need ongoing and regular medical attention from a healthcare provider, other care providers, including long-term care providers, or even family members. In such circumstances, certain activities, such as using the restroom or taking prescribed medications, must be done regularly, at specified intervals or both. For example, persons afflicted with a bacterial infection may be prescribed antibiotics which must be taken regularly, such as twice daily, and taken to completion. Failure to do so could result in a mutation of any surviving bacteria which may render the bacteria more resistant to future antibiotic treatments. Similarly, by way of example, certain conditions, such as kidney disease or diabetes, among a host of medical ailments, are commonly associated with symptoms affecting urination and/or defecation. Indeed, in some circumstances, the frequency or timing of restroom use may be indicative of the onset or exacerbation of certain conditions.

Under some circumstances, as mentioned above, certain individuals need ongoing and regular medical attention. In particular, in circumstances akin to those discussed above, it may be desirable to continuously and regularly monitor and track certain activities of individuals who are infirm. However, healthcare costs or costs associated with healthcare professionals and long-term care providers, which continue to increase, often prohibit or diminish the viability of constant and recurrent observations which in turn diminishes or wholly eliminates usable tracking data. Moreover, the efficacy of monitoring and tracking methods which rely on manual observations and/or recordation is often reduced by inadvertent errors or unintentional lapses in observation. Likewise, it is often impractical or overly burdensome to expect or require family members to continuously and regularly monitor the activities of an infirm individual.

### SUMMARY

This application describes monitoring and/or tracking systems and devices and methods for making and using such systems and devices. In some configurations, a system for monitoring an environment is disclosed. In some configurations, a system includes one or more of the following components: a stationary mounting surface defining an environment; a transmitter coupled to the stationary mounting surface; and a switch having a closed state and an open state. In various configurations, the switch is coupled to the stationary mounting surface. In still other configurations, the switch is electrically coupled to, or otherwise in electrical communication with, the transmitter. In various configurations, the switch occupies the closed state when the environment is in a first condition, the switch is toggled to the open state when the environment is in a second condition and the switch returns to the closed state when the environment returns to the first condition. The system is configured such that the transmitter transmits a first electronic signal corresponding with the closed state of the switch and a second electronic signal corresponding with the open state of the switch. In this way, the system is capable of monitoring and/or tracking events which occur in a given environment.

In some configurations, a method of using a monitoring and/or tracking system is disclosed. For example, in some configurations, a method for monitoring the use of a toilet or a commode is disclosed. In some configurations, the method consists of first providing a monitoring and/or tracking system, such as the system previously discussed. In some configurations, the system includes various features, such as a commode or toilet having a tank which is configured to hold water; a transmitter coupled to the tank; and a switch having a closed state and an open state, wherein the switch is coupled to the tank, and wherein the switch is in electrical communication with the transmitter. In some configurations, the method continues as the tank is allowed to fill with water until the water reaches a first water level, wherein the first water level corresponds with the closed state of the switch. Next, a first signal corresponding with the closed state of the switch is transmitted to a corresponding operating environment and/or a network configuration such that the environment defined by the toilet tank may be monitored and tracked over time. The next step comprises flushing the commode. In this way, the tank is allowed to empty until the water reaches a second level, wherein the second level corresponds with the open state of the switch. Again, a second signal corresponding with the open state of the switch is transmitted. The method continues as the tank is refilled with water until the water again reaches the first level and the switch again occupies the closed state. Finally, the first signal corresponding with the closed state of the switch is retransmitted. In this way, the use of a toilet or commode may be monitored and tracked continuously and regularly.

In other configurations, for example, a method for monitoring the use of a medication-dispensing device is disclosed. In some configurations, the method consists of first providing a medication-dispensing device. In various configurations, such a device includes a container which defines a cavity configured to hold a medication, a closing member coupled to the container and having a lip defining an opening through which the medication is selectively dispensed, a transmitter coupled to the container, and a tilt switch having a closed state and an open state. In various configurations, the tilt switch is physically coupled, either directly or indirectly, to the container and electrically coupled, or in electrical communication with, the transmitter. In further configurations, the closing member defines a first side of the medication-dispensing device and the container further defines a second side of the medication-dispensing device opposite the first side. The method continues as the medication-dispensing device occupies a first orientation comprised of the first side being vertically above the second side, wherein the first orientation corresponds with the closed state of the tilt switch. Next, a first electrical signal corresponding with the closed state of the tilt switch is transmitted followed by orienting the medication-dispensing device in a second orientation comprised of the first side being vertically below the second side, wherein the second orientation corresponds with the open state of the tilt switch. As before, a second electrical signal corresponding with the open state of the tilt switch is then transmitted. The method concludes as the medication-dispensing device is re-oriented so as to assume the first orientation and the first electrical signal corresponding with the closed state of the tilt switch is retransmitted. In this way, the use of a medication-dispensing device may be monitored and tracked continuously and regularly.

### BRIEF DESCRIPTION OF THE DRAWINGS

The following description can be better understood in light of the Figures, in which:

FIG. 1 illustrates some embodiments of an operating environment in which various embodiments of a monitoring and/or tracking system may be implemented;

FIG. 2 illustrates some embodiments of a networked system configuration that may be used in association with embodiments of a monitoring and/or tracking system;

FIG. 3 illustrates a side view of some embodiments of a system for monitoring and/or tracking health related activities;

FIG. 4 illustrates a perspective view of another embodiment of a system for monitoring and/or tracking health related activities;

FIG. 5 illustrates another perspective view of some embodiments of a system for monitoring and/or tracking health related activities; and

FIG. 6 illustrates an explode perspective view of another embodiment of a system for monitoring and/or tracking health related activities.

The Figures illustrate specific aspects of various embodiments of systems and/or devices for monitoring and/or tracking health related activities. Together with the following description, the Figures demonstrate and explain the principles of operation associated with such systems and/or devices and methods for making and using the same. In the drawings, the thickness of layers and regions may be exaggerated for clarity. The same reference numerals in different drawings represent the same element, and thus their descriptions will not be repeated. As the terms on, connected to, attached to, or coupled to are used herein, one object (e.g., a material, a layer, a component, an element, etc.) can be on, connected to, attached to, or coupled to another object regardless of whether the one object is directly on, connected, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand that the systems and devices for monitoring and/or tracking health related activities, and associated methods of making and using such systems or devices, can be implemented and used without employing these specific details. Indeed, the monitoring and tracking systems and associated methods can be placed into practice by modifying the illustrated devices and methods and can be used in conjunction with any other apparatus and techniques conventionally used in the industry. For example, the systems and methods disclosed herein can be used in combination with traditional methods for observation and self-recording of health related activities. Likewise, the systems and methods disclosed herein can be incorporated and/or used in connection with existing automated methods of monitoring and tracking patient behavior in a hospital environment as well as a home-care or nursing home environment.

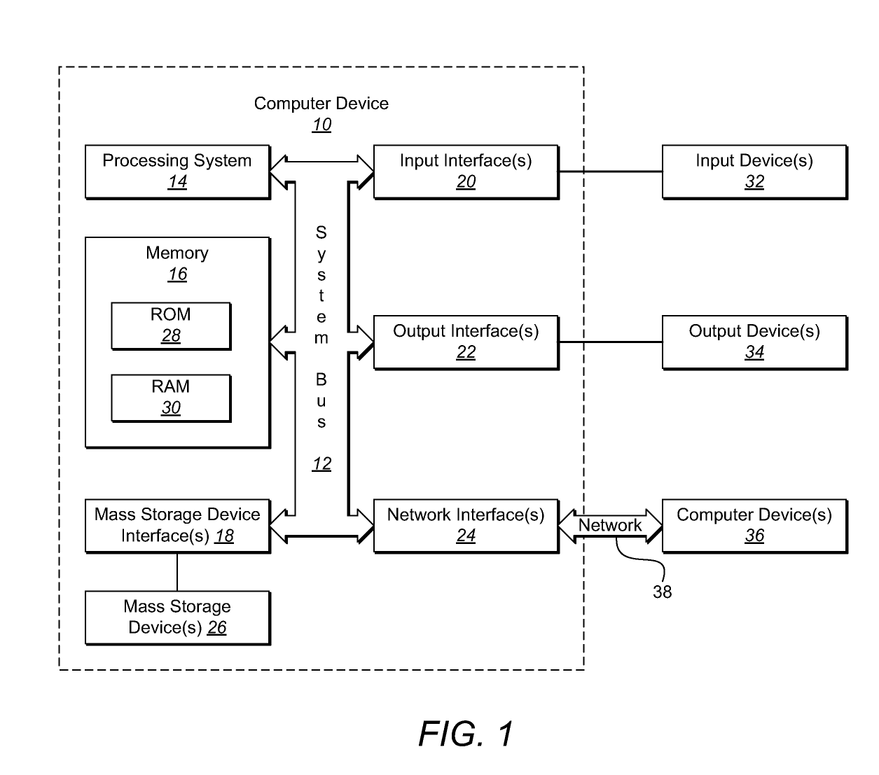

Some embodiments of systems and/or devices for monitoring and/or tracking health related activities are illustrated in the Figures. FIG. 1 and the corresponding discussion are intended to provide a general description of a suitable operating environment in which embodiments of a monitoring and/or tracking system may be implemented or in which embodiments of a monitoring and/or tracking system may be implemented in connection with. One skilled in the art will appreciate that some embodiments of a monitoring and/or tracking system may be practiced by or in connection with one or more computing devices and in a variety of system configurations, including in a networked configuration. However, while the methods and processes disclosed herein have proven to be particularly useful in association with a system comprising a general purpose computer, embodiments of a monitoring and/or tracking system include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of a monitoring and/or tracking system embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of a monitoring and/or tracking system embrace the use of all types of computer-readable media, certain embodiments, as recited in the claims, may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of a monitoring and/or tracking system comprise computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of a monitoring and/or tracking system embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

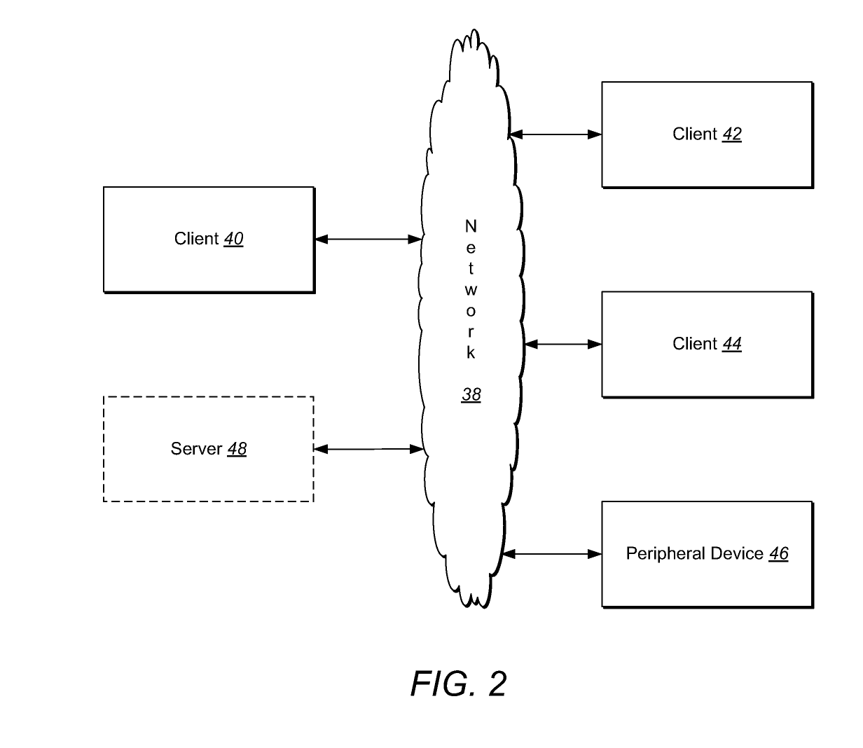

Thus, while those skilled in the art will appreciate that embodiments of a monitoring and/or tracking system may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of a monitoring and/or tracking system include local, networked, or peer-to-peer environments where one or more computer devices may be connected to one or more local or remote peripheral devices. Moreover, embodiments in accordance with a monitoring and/or tracking system also embrace a single electronic consumer device, wireless networked environments, and/or wide area networked environments, such as the Internet.

Similarly, embodiments of a monitoring and/or tracking system embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

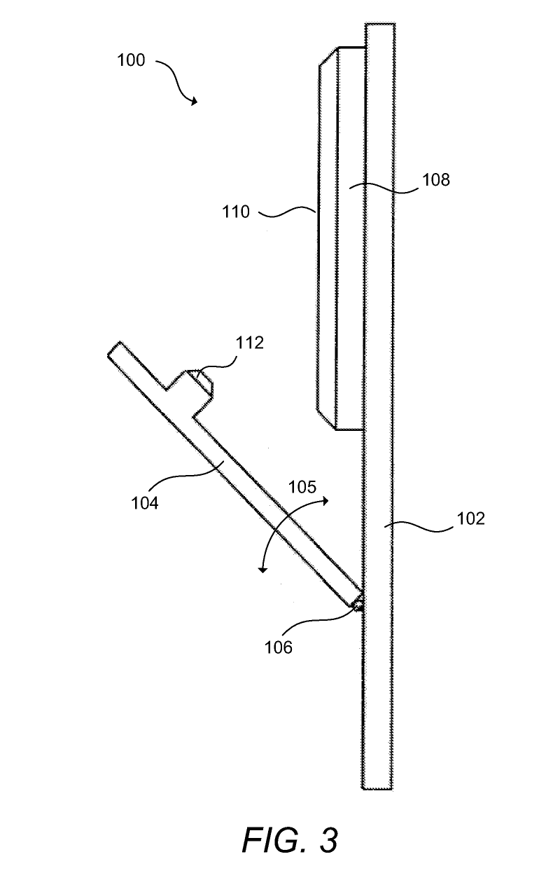

With reference now to FIG. 3, some embodiments of a system 100 will be described in greater detail. As shown in FIG. 3, some embodiments of system 100 comprise various elements, components and/or devices. For example, in some embodiments, system 100 includes a stationary mounting surface 102, an extension 104, a pivot or hinge type mount 106, element 108, a contact surface 110, and/or a switch 112. One or more of the foregoing features may be common to various embodiments of system 100 in order to facilitate methods of using system 100 to monitor and/or track various activities in a select environment, such as health related activities, and thus each such feature or element will be discussed in greater detail below.

At the outset, system 100 is useful for monitoring one or more environment(s) and associated activities which occur in such environments. In some embodiments, for example, system 100 is used to monitor health related activates in a specific environment. By way of example, a suitable environment is defined as a restroom or as certain restroom facilities, such as a toilet or commode, according to some embodiments. In other embodiments, a suitable environment is defined as a medication-dispensing device. In still other embodiments, a suitable environment is defined as the bedroom or living quarters of an infirm individual or an individual who otherwise requires assistance which can be augmented by monitoring and/or tracking certain behaviors of the individual within the relevant environment. While system 100 has proven particularly useful for monitoring and/or tracking the use of health related activities with respect to the use of restroom facilities, such as a toilet or commode, and with respect to the use of medication-dispensing devices, one of skill in the art will appreciate that system 100 and associated methods (discussed below) can be used in myriad environments to track various behaviors and activities. Accordingly, various embodiments of system 100 will be expounded upon through the use of illustrative examples provided below with the understanding that such examples are provided merely as a convenience and not by way of limitation.

As mentioned above, some embodiments of system 100 include stationary mounting surface 102. In various embodiments, stationary mounting surface 102 defines the relevant environment in which specific activities are monitored or in which data is collected which denotes or pertains to certain pre-determined activities. For example, in some embodiments, stationary mounting surface 102 is comprised of the vertical wall of a toilet tank or a toilet reservoir, wherein the tank is configured to hold and temporarily store water used to facilitate the periodic and cyclical flushing of the corresponding toilet. In such embodiments, the relevant environmental activity is the rise and fall of the water level within the tank. Specifically, in various embodiments, the toilet tank is permitted or allowed to fill with water from an integrated or external water source (not shown) until the water reaches a pre-defined height corresponding to a total volume of water necessary for subsequently flushing the toilet on demand at an appropriate juncture. The pre-determined height of the water necessary to adequately flush the toilet represents a first water level according to some embodiments. The first water level denotes the first relevant environmental condition within the environment defined by the tank. Similarly, in various embodiments, the toilet tank may be permitted or allowed to empty by flushing the toilet such that the water within the tank drains into the toilet bowl (not shown) in order to flush or expel the contents of the bowl. The height of the water post-flushing represents a second water level according to such embodiments. Again, the second water level denotes the second relevant environmental condition within the environment defined by the tank.

In various embodiments, alternative environments are contemplated wherein stationary mounting surface 102 comprises any appropriate surface located within a suitable environment so long as the remaining components of the system, to the extent they are employed in the relevant embodiment at issue, are capable of performing their respective functions or roles in sensing and transmitting data about occurrences within the environment at issue.

Some embodiments of system 100 also include an extension 104. In various embodiments, extension 104 is pivotably coupled to stationary mounting surface 102 at pivot or hinge point 106. In this way, extension 104 is permitted to partially rotate about an axis defined through pivot point 106 in the direction 105 to facilitate various features of system 100. In such embodiments, extension 104 is permitted to rotate through an angle defined by the surrounding environment. For example, in some embodiments, stationary mounting surface 102 defines an upper limit on the angle through which extension 104 is permitted to rotate while other environmental feature may define a corresponding lower limit. In other embodiments, extension 104 and pivot or hinge point 106 are oriented such that extension 104 is permitted to rotate through a full three-hundred and sixty degree (360°) angle of rotation denoted at 105.

In some embodiments, extension 104 is buoyant or otherwise capable of floating. Such embodiments are suitable for incorporating extension 104 into embodiments of system 100 wherein stationary mounting surface 102 comprises the vertical wall of a toilet tank, as discussed above. Specifically, in such embodiments, buoyant extension 104 rises when the water in the toilet tank achieves or occupies the first water level as discussed above and buoyant extension 104 falls when the water in the tank or reservoir drops to or otherwise occupies the second water level as discussed above. In such embodiments, extension 104 facilitates the interaction and/or function of other components included within some embodiments of system 100, as discussed in greater detail below.

In various embodiments, extension 104 is made of any suitable material common to those of skill in the art. For example, in some embodiments where extension 104 is configured to float, extension 104 may be made of any sufficiently buoyant material so long as the fluid in which extension 104 floats will not act as a solvent relative to the material selected. In other embodiments, extension 104 may be made of a material that is not inherently buoyant so long as it is manufactured so as to trap air within a sealed cavity defined within extension 104 such that extension 104 will float despite the fact that its constituent material is not buoyant. In still other embodiments, extension 104 is not buoyant and need not float for accomplishing alternative purposes.

Similar to extension 104, pivot or hinge joint 106 may be comprised of any suitable material(s) known to those of skill in the art. In some embodiments, however, pivot or hinge 106 is constructed of materials which are resistant to corrosion such that they remain functional and viable while submerged in a corrosive environment. For example, pivot or hinge 106 may be made of aluminum, nickel-plated steel, zinc-plated steel, and similar anti-corrosive yet robust materials. In alternative embodiments, pivot or hinge 106 may be constructed of plastic and other suitable polymer materials.

Various embodiments of system 100 can include element 108. In some embodiments, element 108 comprises a transmitter. In other embodiments, element 108 comprises a receiver. In still other embodiments, element 108 constitutes a transceiver, comprising both a transmitter and a receiver. In some embodiments, whether element 108 constitutes a transmitter, a receiver or a transceiver, the corresponding unit is wireless and capable of either transmitting or receiving, or both, electrical signals wirelessly. In other embodiments, the relevant unit is wired and capable of transceiving electrical signals by means of a wire. Regardless, in each of the foregoing embodiments, element 108 is configured to handle, either transmit, receive or both, an electronic signal as understood by those of skill in the art. In other words, in some embodiments, transmitter 108 is configured to transmit an electronic signal according to methods common to those of skill in the art. In other embodiments, receiver 108 is configured to receive an electronic signal in the manner commonly understood in the art. And in still other embodiments, transceiver 108 is configured to both transmit and receive electronic signals as commonly practiced in various fields. In some embodiments, element 108 is coupled or otherwise connected to stationary mounting surface 102. For example, in some embodiments, element 102 is coupled to a toilet tank. In such embodiments, element 108 may be waterproof such that it can be coupled on the inside of the tank while in other embodiments element 108 may be coupled on the outside of the tank.

Some embodiments of system 100 also include one or more sensors or switches 112. In various embodiments, sensor(s) or switch(es) 112 comprise one or more contact switches, push switches (or so-called “push-for-on” and/or “push-for-off” switches), pull switches (or so-called “pull-for-on” and/or “pull-for-off” switches), other momentary switches, reed switches, float switches, tilt switches (including mercury and/or rolling-ball type switches) and/or sail switches as well as other toggle switches (i.e., switches having a “open” or “off” state in which the switch is non-conducting and a “closed” or “on” state in which the contacts are touching and electricity can flow between them) common to those of skill in the art. In other embodiments, switch 112 may be comprised of any suitable switch common to those of skill in the art such as switches that are activated by magnetic fields, temperature, pressure, linear force, centrifugal force, axial force, inertia and so forth. In other embodiments, switches 112 may be comprised of latching switches, or switches which selectively lock or latch once toggled into a given position, load control switches, sense switches, thermal switches, time switches, analogue switches, relay switches and any other suitable switches common to those of skill in the art. In still other embodiments, elements 112 may comprise sensors which are capable of generating electrical signals corresponding with a range of orientations as opposed to merely an “on” and “off” or “closed” and “open” position, such as a tilt sensor, an inclinometer or clinometer, a gradient meter or gradiometer, an accelerometer and the like.

In various embodiments, switch 112 is coupled, either directly or indirectly, to stationary mounting surface 102, as seen in FIG. 3 (i.e., switch 112 is coupled to extension 104 which is in turn coupled to stationary mounting surface 102 thus indirectly coupling switch 112 to stationary mounting surface 102). In addition, in various embodiments, switches 112 are electrically coupled or otherwise in electrical communication with element 108, which is some embodiments comprises a transmitter while in other embodiments it comprises either a receiver or a transceiver. In this way, element 108 is configured to transmit electrical signals from switch(es) 112 in order to communicate data about the relevant environment. In such embodiments, the electrical signals are ultimately transmitted or relayed to and received by or in connection with either the operating environment and/or the network configuration, or both, discussed previously with reference to FIGS. 1 and 2 such that the relevant data can be received, stored, tracked, aggregated or otherwise processed in a suitable and appropriate way according to desirable subsequent uses for such data. In various embodiments, the operating environment and/or the network configuration may in turn transmit relevant data back to receiver/transceiver 108.

With continued reference to FIG. 3, in some embodiments, as mentioned above, switch 112 is coupled to extension 104. In such embodiments, switch 112 may comprise one of a toggle contact switch or a momentary push-for-on type switch. For example, in some embodiments, switch 112 is a reed switch which is toggled or activated by the presence of a magnetic field which interacts with metallic reeds housed within the switch as the switch is oriented proximate a magnetic source. In such embodiments, system 100 further includes or comprises a magnetic contact surface 110. As discussed above, in embodiments contemplating a pivotable connection between extension 104 and stationary mounting surface 102, switch 112 is capable of being oriented proximate magnetic contact surface 110 when extension 104 is in the proper orientation. In this way, magnetic surface 104 changes switch 112 to a closed state under the appropriate environmental conditions. Conversely, as the environmental conditions change, extension 104 is allowed to move or rotate such that switch 112 moves distally relative to magnetic contact surface 110. In this way, switch 112 is changed to an open state under the appropriate environmental conditions. In such embodiments, the environmental conditions corresponding with the closed and open states of switch 112 can be cyclically and repeatedly changed.

In embodiments contemplating a buoyant or otherwise floatable extension 104, the rotatable movement of extension 104 in the direction 105, and the relative displacement of switch 112, coincide with the rise and fall of the water level temporarily and cyclically stored within the tank comprised of stationary mounting surface 102 as discussed above. In other words, in some embodiments, the environmental condition of the tank which corresponds with the closed state of switch 112 occurs when the water level achieves the first water level discussed previously while the environmental condition of the tank which corresponds with the open state of switch 112 occurs when the toilet is flushed and the water level is permitted to decrease until achieving the second water lever discussed previously. As the water level in the tank changes, and the state of switch 112 alternates as previously discussed, the switch generates an electronic signal which is then transmitted or relayed by transmitter 108. In some embodiments, the transmitted or relayed signal is received and processed by or in connection with either the operating environment and/or the network configuration, or both, discussed previously with reference to FIGS. 1 and 2. In this way, system 100 is capable of monitoring and tracking changes which occur within the toilet tank, which generally correspond with a user's use of the toilet. In some embodiments, the time of day that the toilet was flushed is also recorded.

Still with reference to FIG. 3, in some embodiments, switch 112 is a momentary push-for-on type switch or simply a push switch which is activated as switch 112 is pushed or depressed against a stationary contact surface and deactivated as switch 112 is released or moved distally with respect to the stationary contact surface. In other words, switch 112 occupies the closed state when depressed and the open state when released. In such embodiments, system 100 further includes or comprises a stationary contact surface 110. In some embodiments, stationary contact surface 110 is comprised of the stationary mounting surface 102. In other embodiments, an exterior surface of element 108 doubles as the contact surface 110. In still other embodiments, other objects act as the contact surface against which switch 112 may be cyclically depressed.

Similar to embodiments incorporating a reed switch, as previously discussed, in embodiments having a push switch 112, the switch is pushed or depressed against the stationary contact surface 110 as buoyant extension 104 rises thus causing push switch 112 to occupy the closed state when the water occupies the first water level. Conversely, push switch 112 is released as buoyant extension 104 falls thus allowing push switch 112 to occupy the open state when the water occupies the second water level. By electrically coupling push switch 112 with transmitter 108, the state of the push switch, or a corresponding electrical signal, is capable of being transmitted or relayed via system 100 to a corresponding operating environment and/or the network configuration such that the environment defined by the toilet tank may be monitored and tracked over time.

While various embodiments have been discussed with reference to particular orientations of switch 112 corresponding with either the “open” state of switch 112 or the “closed” state of switch 112, in other embodiments the orientation of switch 112 corresponds with an infinite number of electrical signals which are capable of communicating the precise orientation of switch 112 and not merely one of two discrete orientations. Similarly, in some embodiments, a first orientation corresponds with a closed state while a second orientation corresponds with an open state. In other embodiments, however, the first orientation corresponds with the open state while the second orientation corresponds with the closed state. In other words, switch 112 may be configured to conduct an electrical current in any specific orientation. Similarly, switch 112 may be configured such that it is non-conducting in any desirable orientation. The foregoing is equally true for switches 118, 120 and 228 discussed in greater detail below.

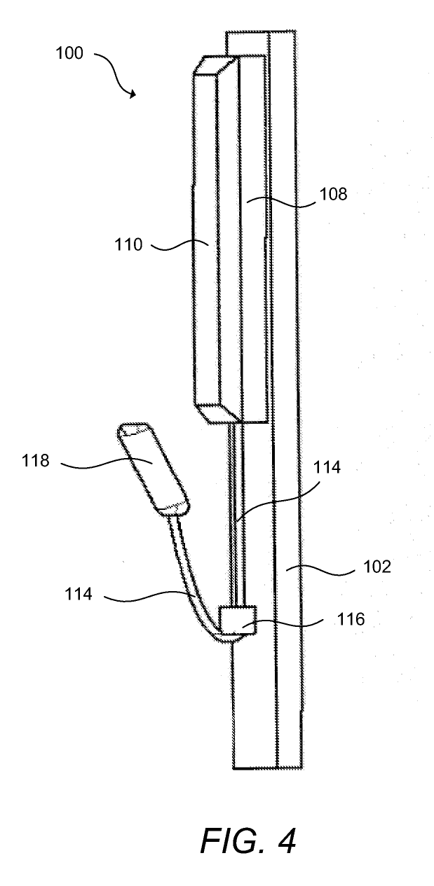

With reference now to FIG. 4, another alternative embodiment of system 100 will be described in greater detail. As shown in FIG. 4, some embodiments of system 100 further comprise a lanyard 114, which in some embodiments is coupled to the stationary mounting surface 102, and an anchor pivot 116, which is some embodiments is coupled to lanyard 114. In some embodiments, as depicted in FIG. 4, lanyard 114 is coupled to element 108 which is in turn coupled to stationary mounting surface 102. In this way, lanyard 114 is indirectly coupled to stationary mounting surface 102. In some embodiments, lanyard 114 comprises an electrical connection between switch 118 and element 108 (which, as above, comprises one of a transmitter, a receiver, and a transceiver according to various embodiments). In other embodiments, lanyard 114 is merely a tether configured to properly orient switch 118 according to the surrounding environmental condition or conditions.

In some embodiments, anchor pivot 116 is coupled or otherwise fixed to stationary mounting surface 102. In some embodiments, anchor pivot 116 circumscribes or annularly surrounds lanyard 114 such that it encompasses the entire circumference or outer perimeter of lanyard 114 at a given segment of lanyard 114. In other embodiments, where anchor pivot 116 is coupled to stationary mounting surface 102, anchor pivot 116 forms a “U” shape such that it captures lanyard 114 within the cavity of the “U” and mounts to stationary mounting surface 102 at the flanges of the “U”. In still other embodiments, anchor pivot 116 is merely a weight or mass coupled to lanyard 114 such that it applies a downward force via gravity to lanyard 114 at the location where anchor pivot 116 and lanyard 114 are coupled to one another. In some embodiments, anchor pivot 116 is affixed to lanyard 114 at a permanent location. In other embodiments, however, anchor pivot 116 is coupled to lanyard 114 such that it is adjustable or movable relative to lanyard 114. In such embodiments, anchor pivot 116 may be removed from lanyard 114 altogether or repositioned relative to lanyard 114 so as to adjust the loose length or end of lanyard 114 such that system 100 operates as intended.

In various embodiments of system 100, the system includes switch 118. In some embodiments, switch 118 is similar to switch 112 and may comprise one or more contact switches, push switches, pull switches, other momentary switches, reed switches, float switches, tilt switches and/or sail switches as well as other toggle switches as previously described and common to those of skill in the art. In other embodiments, switch 118 comprises one or more sensors common to those of skill in the art, such as a tilt sensor or an accelerometer.

In some embodiments, as illustrated in FIG. 4, switch 118 is coupled to lanyard 114. In this way, switch 118 is indirectly coupled to stationary surface 102 according to some embodiments. In some embodiments, switch 118 comprises one of a float switch and/or a tilt switch. For example, in some embodiments, switch 118 is a float switch which is toggled between a closed state and an open state according to the fluid level in the surrounding environment and the corresponding orientation of switch 118. Specifically, according to some embodiments, wherein the surrounding environment is comprised of a toilet tank, float switch 118 resides in the water held within the tank. In this way, float switch 118 is capable of being transitioned between a closed state and an open state under the appropriate environmental conditions. In such embodiments, the environmental conditions corresponding with the closed and open states of switch 118 can be cyclically and repeatedly changed.

In embodiments contemplating a float switch 118, the displacement of float switch 118, and the corresponding toggling of switch 118 between its open and closed states, coincides with the rise and fall of the water level temporarily and cyclically stored within the tank comprised of stationary mounting surface 102 as discussed above. In some embodiments, for example, the environmental condition of the tank which corresponds with the closed state of switch 118 occurs when the water level achieves the first water level discussed previously while the environmental condition of the tank which corresponds with the open state of switch 118 occurs when the toilet is flushed and the water level is permitted to decrease until achieving the second water lever discussed previously. As the water level in the tank changes, and the state of switch 118 alternates as previously discussed, the switch generates an electronic signal which is then transmitted or relayed by transmitter 108. By electrically coupling float switch 118 with transmitter 108, the state of the float switch 118, or a corresponding electrical signal, is capable of being transmitted or relayed via system 100 to a corresponding operating environment and/or the network configuration such that the environment defined by the toilet tank may be monitored and tracked over time.

In various embodiments, anchor pivot 116 facilitates properly orienting float switch 118 such that it is toggled between its open and closed states as the water level fluctuates between the first water level and the second water level. Specifically, in some embodiments, anchor pivot 116 remains stationary or otherwise applies a constant downward force to lanyard 114. In such embodiments, when float switch 118 rises relative to anchor pivot 116 (i.e., when the water level within the tank achieves or occupies the first water level thus lifting float switch 118) float switch 118 is restrained by lanyard 114 in combination with the mass provided by anchor point 116 such that the combination of upward force applied to switch 118 from the rising water coupled with the downward force applied to switch 118 at the point where switch 118 is coupled to lanyard 114 orients the switch 118 such that it occupies a closed state. Conversely, when the water level drops (corresponding with a flush of the tank) and achieves or occupies the second water level, switch 118 correspondingly falls relative to anchor pivot 116 and is thereby reoriented such that switch 118 occupies the open state. As the water level rises, again achieving the first water level, switch 118 is also reoriented so as to reassume the closed state. In this way, anchor point 116 facilitates the efficient translation or transition of switch 118 between its opened and closed states.

In some embodiments, switch 118 comprises a tilt switch which is encapsulated within a buoyant or otherwise floatable material, such as Styrofoam or other materials which can be permanently or temporarily inflated or otherwise encapsulate air. In such embodiments, any tilt switch (or tilt sensor) is capable of being incorporated in system 100 and functioning as described with reference to the float switch described and discussed previously.

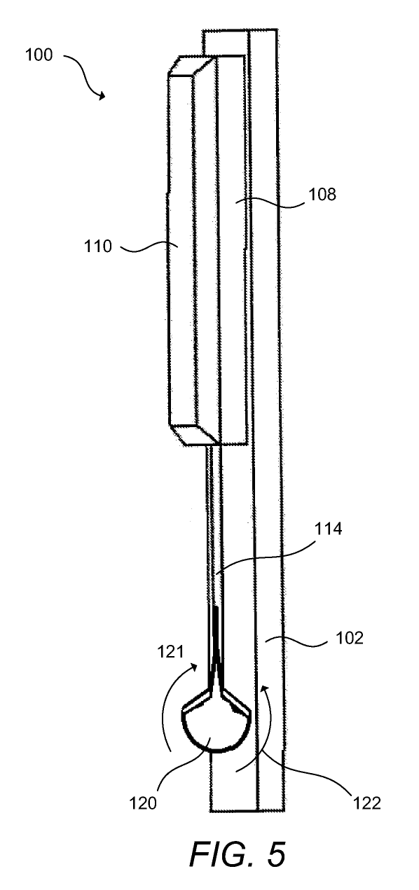

With brief reference to FIG. 5, in some embodiments, system 100 incorporates a sail switch 120. In such embodiments, sail switch 120 is pivotably coupled to stationary surface 102 and in electrical communication with element 108 (which, as above, comprises one of a transmitter, a receiver, and a transceiver according to various embodiments) via electrically conductive lanyard 114. In such embodiments, sail switch 120 includes a “sail” or “rudder” type formation. As water flows over the sail or rudder, sail switch 120 is oriented such that it occupies the closed state under one direction of fluid flow and the open state under the opposite direction of fluid flow. In other words, as the tank fills up, sail switch 120 is acted upon by the rising water such that it rotates in the direction denoted by arrow 121. Conversely, as the tank empties or is flushed, sail switch 120 is acted upon by the falling water such that it rotates in the direction denoted by arrow 122. In this way, as the toilet is cyclically flushed and allowed to refill with water, the sail switch 120 is correspondingly toggled between the closed state and the open state and, via element 108, system 100 is capable of transmitting or relaying the status of switch 120 such that the toilet tank environment may be monitored and tracked over time as discussed with reference to other embodiments previously. In various embodiments, sail switch 120 is balanced and weighted so as to accommodate the function described above. In other embodiments, portions of sail switch 120 are formed from a buoyant or otherwise floatable material or construction to further enhance the functionality of sail switch 120.

With reference to the various embodiments disclosed and described above, a method of using such embodiments is also contemplated. In other words, a method for monitoring the use of a toilet or a commode is disclosed. In some embodiments, the method consists of first providing a system, such as system 100. In some embodiments, system 100 includes the various features discussed previously, such as a commode or toilet having a tank which is configured to hold water; a wireless transmitter 108 coupled to the tank; and a switch 112/118/120 having a closed state and an open state, wherein the switch is coupled to the tank, and wherein the switch is in electrical communication with the wireless transmitter 108. The method continues as the tank is allowed to fill with water until the water reaches a first water level, wherein the first water level corresponds with the closed state of the switch. Next, a first wireless signal corresponding with the closed state of the switch is transmitted to a corresponding operating environment and/or the network configuration discussed with reference to FIGS. 1 and 2 such that the environment defined by the toilet tank may be monitored and tracked over time. The next step comprises flushing the commode. In this way, the tank is allowed to empty until the water reaches a second level, wherein the second level corresponds with the open state of the switch 112/118/120. Again, a second wireless signal corresponding with the open state of the switch is transmitted. The method continues as the tank is refilled with water until the water again reaches the first level and the switch again occupies the closed state. Finally, the first wireless signal corresponding with the closed state of the switch is retransmitted. In this way, the use of a toilet or commode may be monitored and tracked continuously and regularly.

In the various embodiments shown and described with reference to FIGS. 3 through 5, a power sources, such as a battery, is also incorporated within system 100 to facilitate the development of an electrical signal from switches 112, 118 and/or 120 as well as an electrical transmission of the signal from element 108. Various batteries or other sources of power are contemplated consistent with methods common to those of skill in the art.

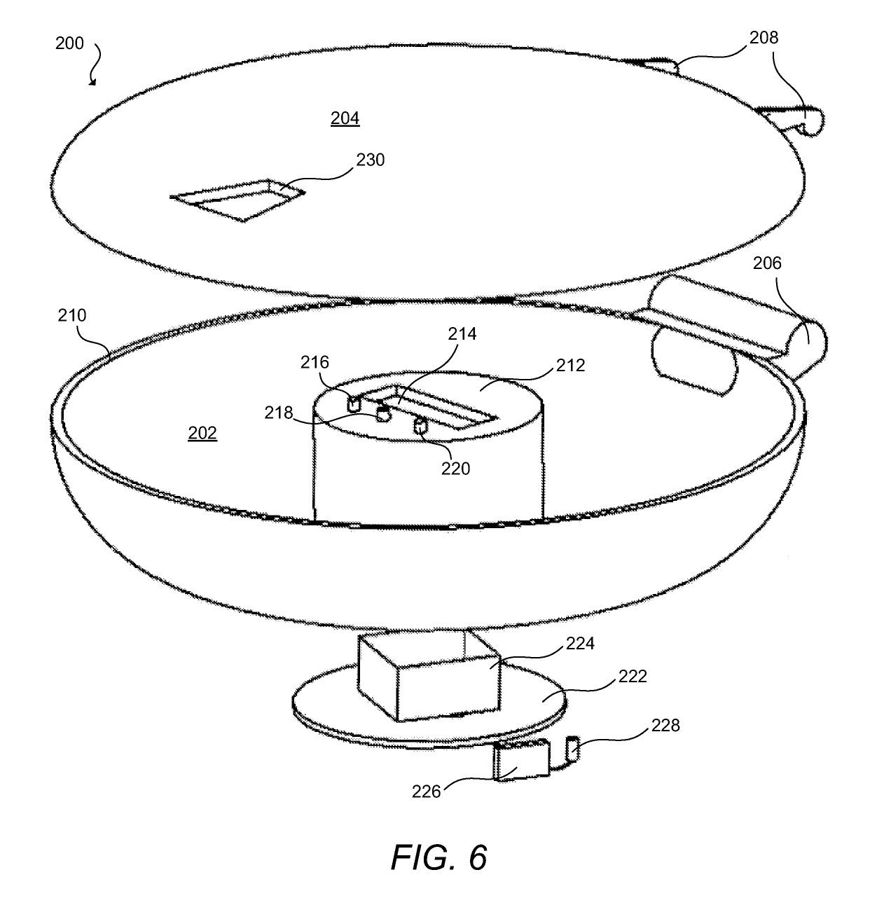

With reference now to FIG. 6, another alternative embodiment of a monitoring and/or tracking system 200 is described. As illustrated in FIG. 6, some embodiments of system 200 comprise various elements, components and/or devices. For example, in some embodiments, system 200 includes a stationary mounting surface or container 202, a closing member 204, a pivot or hinge type mount 206, one or more pivotable connectors 208 configured to facilitate a pivotable connection or coupling engagement between container 202 and closing member 204, a control module 212 comprising a viewing window 214 and various operation buttons or switches 216, 218, and/or 220, a cover 222, which in some embodiments includes a compartment or defines an internal cavity 224, an element 226 and/or a switch 228. One or more of the foregoing features may be common to various embodiments of system 200 in order to facilitate methods of using system 200 to monitor and/or track various activities in a select environment, such as health related activities, and thus each such feature or element will be discussed in greater detail below.

In some embodiments, container or stationary mounting surface 202 includes lip 210 which defines a cavity formed by container 202. In various embodiments, container 202 further comprises one or more separators, vertical flanges, dividers, or other compartments (not shown) configured for separating discrete contents of container 202 from one another when all such contents are placed within container 202. For example, in some embodiments, system 200 is configured to hold and periodically dispense medication or medicinal pills to a user. In other words, system 200 comprises a medication-dispensing system according to some embodiments. In such embodiments, container 202 includes various means, such as separators, vertical flanges, dividers, or other compartments (not shown) in order to maintain separation between various independent medications or pills that are to be dispensed, administered and/or consumed at separate times. In various embodiments, container 202 also includes or comprises a series of gears and timers which correspond with the separators, vertical flanges, dividers, or other compartments previously described (none of which are shown) such that the medication-dispenser continuously provides access to the appropriate medication at an appropriate time in an automated fashion.

In various embodiments, the automation of medication-dispensing system 200 is accessed and facilitated by a user via control module 212. By means, such as buttons or switches 216, 218 and/or 220, a user is allowed to enter relevant information into system 200. For example, a user can program the system 200 such that the same medication is available to be dispensed at four uniformly spaced times every day. In alternative embodiments, a user can program the system 200 such that the same medication is available to be dispensed once a day for an extended period of time, such as a week, two weeks, or several days. Various additional automation may be programmed into system 200 via control module 212 such that a user may use system 200 to retrieve an appropriate dose of a given medication at an appropriate time as understood by those of skill in the art. Through viewing window 214, the user can observe and monitor data as it is being input into system 200. In other embodiments, control module 212 can communicate relevant information to a user via viewing window 214. In some embodiments, control module 212 also includes an alarm or audio reminder system, including a timer and a means for sounding an alarm, such as a digital, physical, or analogue ringer. In various embodiments, the internal cavity defined by compartment 224 is configured to hold means for facilitating the function of system 200 and/or control module 212, such as a battery or other electronic components.

In some embodiments, closing member 204 includes a lip 230 which defines an opening within closing member 204. In such embodiments, the opening defined by lip 228 is configured such that medication or medicinal pills can be selectively dispensed from system 200 via the opening. In some embodiments, as illustrated in FIG. 6, the opening defined by lip 230 is formed within the “top” side of system 200. In this way, medication can only be retrieved from system 200 when the system is turned upside down. In other words, in some embodiments, closing member 204 defines a first side of the medication-dispensing device 200 and container 202 further defines a second side of the medication-dispensing device 200 opposite the first side and the opening defined by lip 230 is formed within the first side. In additional embodiments, the opening defined by lip 230 only permits access to a single internal compartment (not shown) of container 202 at any given time so that a user can only retrieve the medication found in the corresponding compartment. In such embodiments, the opening defined by lip 230 correlates with the programming of system 200 such that the appropriate compartment is oriented relative to the opening, thus providing access to the appropriate medication, at the appropriate time. Such features can be automated as described above.

In various embodiments, system 200 includes element 226. In such embodiments, element 226 is similar to element 108 previously discussed with reference to FIGS. 3 through 5. In other words, element 226 is a transmitter in some embodiments, a receiver in other embodiments and a transceiver in yet other embodiments. Element 225 operates and functions similarly to element 108 and a discussion of the same has been previously provided.

In some embodiments, system 200 further includes switch 228. Again, switch 228, according to some embodiments, is similar to switches 112, 118 and/or 120 and may comprise one or more contact switches, push switches, pull switches, other momentary switches, reed switches, float switches, tilt switches and/or sail switches as well as other toggle switches as previously described and common to those of skill in the art. In other embodiments, switch 228 comprises one or more sensors common to those of skill in the art, such as a tilt sensor or an accelerometer.

For example, in some embodiments, switch 228 comprises a tilt switch. In such embodiments, the title switch 228 has a closed state and an open state consistent with the discussion previously provided. As illustrated in FIG. 6, according to some embodiments, the closed state of switch 228 corresponds to an orientation of system 200 wherein the closing member 204 (which defines the first side of the medication-dispending device as discussed above) is vertically above the container 202 (which defines the second side of the medication-dispending device as discussed above). In such embodiments, switch 228 is capable of being toggled to the open state when the medication-dispending device is flipped over such that the closing member 204 or first side is oriented vertically below the container 202 or the second side. In other words, switch 228 is toggled between a closed state and an open state by flipping the medication-dispensing device 200 over such that the top is upside down and the bottom is facing upwards. Put differently, the switch 228 may be toggled back and forth between the closed state and the open state by cyclically flipping the medication-dispending device over.

In this way, switch 228 occupies the closed state prior to a medication being dispensed via the opening defined by lip 230. As the system migrates or transitions over time such that the opening corresponds with an available medication, the medication-dispending device is flipped over in order to allow the user to retrieve the medication from the medication-dispending device via the opening in the top side thereof. As the medication-dispending device is flipped over, switch 228 is toggled to the open state. Once the medication is successfully retrieved, the medication-dispending device is returned to its top side up orientation and switch 228 once again assumes the closed state. In this way, use of the system 200 may be monitored and tracked over time as signals corresponding with the various states of switch 228 are transmitted via element 226 and received by the operating environment and/or the network configuration discussed with reference to FIGS. 1 and 2.

With reference to the various embodiments disclosed and described in relation to FIG. 6, a method of using such embodiments is also contemplated. In other words, a method for monitoring the use of a medication-dispensing device 200 is disclosed. In some embodiments, the method consists of first providing a medication-dispensing device 200. In various embodiments, such devices includes the container 202 which defines a cavity configured to hold a medication, the closing member 204 pivotably coupled to the container and having a lip 230 defining an opening through which the medication is selectively dispensed, a transmitter 226 coupled to the container, and a tilt switch 230 having a closed state and an open state. In various embodiments, the tilt switch 230 is physically coupled, either directly or indirectly, to the container and electrically coupled, or in electrical communication with, the transmitter. In further embodiments, the closing member defines a first side of the medication-dispensing device and the container further defines a second side of the medication-dispensing device opposite the first side. The method continues as the medication-dispensing device occupies a first orientation comprised of the first side being vertically above the second side, wherein the first orientation corresponds with the closed state of the tilt switch. Next, a first wireless signal corresponding with the closed state of the tilt switch 228 is transmitted followed by orienting the medication-dispensing device in a second orientation comprised of the first side being vertically below the second side, wherein the second orientation corresponds with the open state of the tilt switch. As before, a second wireless signal corresponding with the open state of the tilt switch is then transmitted. The method concludes as the medication-dispensing device 200 is re-oriented so as to assume the first orientation and the first wireless signal corresponding with the closed state of the tilt switch is retransmitted. In this way, the use of a medication-dispensing device 200 may be monitored and tracked continuously and regularly.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A sensor for monitoring an environment, comprising:
a stationary mounting surface defining an environment;
a wireless transmitter coupled to the stationary mounting surface; and
a switch having a closed state and an open state, wherein the switch is coupled to the stationary mounting surface and is in electrical communication with the wireless transmitter; wherein the switch occupies the closed state when the environment is in a first condition and the switch toggles to the open state when the environment is in a second condition, and wherein the wireless transmitter transmits a first wireless signal corresponding with the closed state of the switch and a second wireless signal corresponding to the open state of the switch.

2. The sensor of claim 1, wherein the switch comprises a contact switch, a push switch, a pull switch, a reed switch, a float switch, a tilt switch, a sail switch, or a combination thereof.

3. The sensor of claim 1, wherein the stationary mounting surface comprises a toilet tank configured to hold water.

4. The sensor of claim 3, wherein the first environmental condition comprises a first water level in the toilet tank and the second environmental condition comprises a second water level in the toilet tank.

5. The sensor of claim 4, further comprising a buoyant extension pivotably coupled to the toilet tank and the switch is coupled to the buoyant extension.

6. The sensor of claim 5, wherein the buoyant extension rises when the water occupies the first water level and falls when the water occupies the second water level.

7. The sensor of claim 6, further comprising a magnetic surface coupled to the toilet tank.

8. The sensor of claim 7, wherein the switch comprises a reed switch that is configured to occupy the closed state when proximate the magnetic surface and is configured to occupy the open state when moved distally with respect to the magnetic surface.

9. The sensor of claim 6, wherein the switch comprises a push switch that is pushed against the toilet tank as the buoyant extension rises and falls.

10. The sensor of claim 4, further comprising:
a lanyard coupled to the toilet tank; and
an anchor pivot coupled to the lanyard.

11. The sensor of claim 10, wherein the switch comprises a float switch that is coupled to the lanyard.

12. The sensor of claim 11, wherein the anchor pivot remains stationary and the float switch rises and falls relative to the anchor pivot.

13. The sensor of claim 4, wherein the switch comprises a sail switch that is pivotably coupled to the toilet tank.

14. A method for monitoring the use of a commode, comprising:
providing a commode comprising a tank, a wireless transmitter coupled to the tank, and a switch coupled to the tank and in electrical communication with the wireless transmitter, the switch having a closed state and an open state;
transmitting a first wireless signal corresponding to the closed state of the switch when water in the tank reaches a first level; and
transmitting a second wireless signal corresponding with the open state of the switch when water in the tank reaches a second level.

15. A method for monitoring the use of a medication-dispensing device, comprising:
providing a medication-dispensing device, comprising:
a container having a cavity configured to hold a medication;
a closing member coupled to the container and having a lip defining an opening through which the medication is selectively dispensed, the closing member defining a first side of the medication-dispensing device and defining a second side of the medication-dispensing device opposite the first side;
a wireless transmitter coupled to the container; and
a tilt switch coupled to the container and in electrical communication with the wireless transmitter, the tilt switch having a closed state and an open state;
transmitting a first wireless signal corresponding to the closed state of the tilt switch when the medication-dispensing device is in a first orientation with the first side being vertically above the second side; and
transmitting a second wireless signal corresponding to the open state of the tilt switch when the medication-dispensing device is in a second orientation with the first side being vertically below the second side.

16. A system for monitoring an environment, comprising:
a sensor including:
a stationary mounting surface defining an environment;
a wireless transmitter coupled to the stationary mounting surface; and
a switch coupled to the stationary mounting surface and in electrical communication with the wireless transmitter, the switch in the closed state when the environment is in a first condition and toggles to the open state when the environment is in a second condition, wherein the wireless transmitter transmits a first wireless signal corresponding with the closed state of the switch and a second wireless signal corresponding to the open state of the switch; and
a medication-dispensing device mounted to stationary mounting surface and comprising:
a container defining a cavity configured to hold a medication; and
a closing member coupled to the container and having a lip defining an opening through which the medication is selectively dispensed, wherein the closing member defines a first side of the medication-dispensing device and the container further defines a second side of the medication-dispensing device opposite the first side.

17. The system of claim 16, wherein the switch comprises a contact switch, a push switch, a pull switch, a reed switch, a float switch, a tilt switch, a sail switch, or a combination thereof.

18. The system of claim 17, wherein the stationary mounting surface comprises a toilet tank configured to hold water.

19. The system of claim 18, wherein the first environmental condition comprises a first water level in the toilet tank and the second environmental condition comprises a second water level in the toilet tank.
